(19) United States
(12) Patent Application Publication
(10) Pub. No.: US 2006/0063861 A1
(43) Pub. Date: Mar. 23, 2006

(54) Method for employing colorants as indicators in polymer blending

(75) Inventor: Philip T. Radford, Roebuck, SC (US)

Correspondence Address: John E. Vick, Jr.;Legal Department , M-495, PO Box 1926, Spartanburg, SC, 29304, US

(73) Assignee: Milliken & Company

(21) Appl. No.: 10/943,415

(22) Filed: Sep. 17, 2004

(51) Int. Cl. C08J 3/00

(52) U.S. Cl. 523/303

(57) ABSTRACT

In the formation of polymeric materials using a two or more component reactant mixture (i.e. A/B system) and a pigment or colorant, the color of the final product can be used as an indicator to reveal if the correct ratio of A/B is being applied in forming a polymer product. Exact measurement of color may be proportional to the amount of color used in the original reactants A and B. Thus, this enables relatively fast adjustment of the reactant ratio A/B based upon measured color results of the final polymeric product. Too much of a first color indicates a corresponding excess of the first reactant, while too much of the second color indicates an excess of the second reactant. The system has application to polyurethane materials.

### BACKGROUND OF THE INVENTION

Polymeric colorants are employed commercially for coloring polymers. Such colorants may be used in coloring two component polyurethane systems, for example. Polymeric colorants include, for example, the Reactint® product line manufactured and distributed by Milliken and Company of Spartanburg, S.C., USA, described in U.S. Pat. Nos. 5,290,921; 5,925,150; and 6,077,927.

Colorants are commonly used in the manufacture of polyurethane articles. Poly(oxyalkylene) substituted colorants have been found to be particularly useful in that they may react with the polyisocyanate monomers to become permanently bound in the resin. Examples of such colorants may be found in the following United States Patents: Cross et al. U.S. Pat. No. 4,284,729; Kluger et al. U.S. Pat. No. 4,507,407; Kluger et al. U.S. Pat. No. 4,751,254 Kluger et al. U.S. Pat. No. 4,761,502; Kluger, et al. U.S. Pat. No. 4,775,748; Rekers et al. U.S. Pat. No. 4,846,846; Kluger et al. U.S. Pat. No. 4,912,203; and Kluger et al. U.S. Pat. No. 4,978,362.

One class of polyurethane is a two component system where an A-side (isocyanate) usually is mixed with a B-side (typically a polyol) to form a urethane system. The ratio of the amount of reactant used in the A-side and the B-side (i.e. the A/B ratio) is critical to the final part being manufactured. It is important that the A and B side materials be thoroughly mixed as the homogeneity of the two materials also has a dramatic effect on the final urethane being formed. Inadequate mixing results in a poor quality product.

What is needed in the industry are better methods for determining that multi-component polymer systems are mixed in the appropriate ratio. Furthermore, a system that makes it possible to make such a determination, and then adjust the reactant mix ratio in response to such a measured determination, would be very helpful.

### BRIEF DESCRIPTION OF THE DRAWINGS

A full and enabling disclosure of this invention, including the best mode shown to one of ordinary skill in the art, is set forth in this specification. The following Figures illustrate the invention:

FIG. 1 is an illustration showing one example of the color blending of the A component (yellow) and B component (blue) of a two color/ two component polymer system;

FIG. 2 shows a L,a,b color space diagram to illustrate the blending of two colors, and how the shade may vary along the green spectrum between yellow and blue;

FIG. 3 shows a schematic of the apparatus employed in the A/B mixing system; and

FIG. 4 is a functional diagram explaining the steps and procedures in the process for determining the degree or amount of colorant used in each A and B component by study of the final color of the blended polymer.

### DETAILED DESCRIPTION OF THE INVENTION

Reference now will be made to the embodiments of the invention, one or more examples of which are set forth below. Each example is provided by way of explanation of the invention, not as a limitation of the invention. In fact, it will be apparent to those skilled in the art that various modifications and variations can be made in this invention without departing from the scope or spirit of the invention.

The invention may be applied to essentially any two or three or more component polymer system, in which a polymer, or a polymer foam, results from the mixture of two or more components. In one example of such a system, “A” and “B”, provide a two-component system in polyurethane. In the practice of the invention, color can be used as an indicator to reveal if the correct ratio of A/B is being applied in forming a polymer product. That is, the exact measurement of color may be proportional to the amount of color used in the original reactants A and B, enabling ready and relatively fast remediation of the reactant ratio based upon measured color results. That is, too much of a first color indicates a corresponding excess of the first reactant, while too much of the second color indicates an excess of the second reactant.

In one embodiment of the invention, as applied to polyurethanes, a first color is employed in the A-side (isocyanate) and a second color is employed in the B-side (polyol). When the two colored components are mixed the final blend (product) has a third color, which results from the blend of the first and second colors. Careful measurement of the third color can give an analytical tool to describe or adjust (in a feedback response) the original ratio A/B. Thus, it has been determined that the uniformity of the final color gives a measure of the ratio of the two parts that have been mixed together. “Coloring components” or “coloring agents” may include polymeric colorants, or dyes, or other coloring media, or a combination of one or more of the same.

A method is disclosed in the practice of the invention for measuring the amount of at least one reactant used in forming a polymeric material. The method includes providing a first reactant having a first polymeric colorant, and a second reactant having a second polymeric colorant. Then, the respective reactants are reacted to form a polymeric material. The polymeric material exhibits a color shade. Then, the color shade may be measured in color space values, or may be done manually, by simply visually matching the color shade to a set of predetermined color swatches. The color values are correlated with a predetermined set of reactant ratios (i.e. A:B) of the polymeric material to determine the relative proportion of said first reactant to said second reactant. Thus, the ratio may be determined in this way.

In one embodiment of the invention, one may compare said determined relative proportion with a predetermined value, and then adjust the relative proportion of said the first reactant to the second reactant, thereby “tuning” the relative proportion to a desired ratio. A table or set of values may be manually investigated, or predetermined values may be loaded into memory in an automated system. This enables the real time adjustment of reactant ratios by monitoring color shade of the polymeric material formed in the reaction. This ratio could be adjusted “on the fly” during a manufacturing operation, for example.

Furthermore, it is possible to apply the invention to a multi-component system having three or more colors. Thus, a polymer formed by mixing an A:B:C in a given ratio also could be employed in the practice of the invention, using a three dimensional color coordinate system.

In the practice of the invention, care is taken to ensure that the two sides are carefully metered and thoroughly mixed. Physical properties of the finished part or product may indicate the correct ratio of A to B, but this approach may require extensive testing. Poor mixing of the two components can be identified by the observation of hard and soft urethane segments in the finished part, in the case of polyurethane applications. Inaccurate dosing and poor mixing in blending result in finished parts that have diminished physical properties that may result in catastrophic failure of the part. Thus, the ratio of A/B is critical, and measuring and administering A and B together in the appropriate ratio is very important.

The invention describes a straightforward method to measure the uniformity and accuracy of the ratio of the A-side and the B-side in polyurethane materials. The approach does not require extensive physical testing but allows the quick routine measure of color as an indicator of accuracy and uniformity. Once measured, the measurement may be used to respond (i.e. feedback) and thereby adjust the mix ratio as needed, to prepare products or parts of high quality.

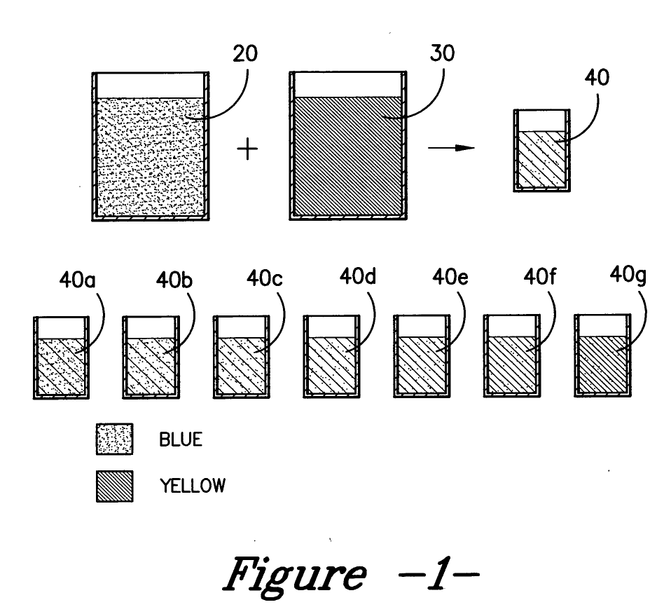

FIG. 1 shows schematically the mixing of the A component 20 with a B component 30 to form a polymer product 40. In FIG. 1, the A component is blue, and the B component is yellow. Thus, a green polymer product 40 results. Color is shown in the Figure by shading. Shade variants 40a-g illustrate the various shades that are possible in the product 40, depending upon the amount of colorant in A and B components, respectively. A greater amount of colorant in A results in a more bluish final green product 40, while a greater amount of colorant in B results in a more yellowish product 40, as illustrated by the shading in the lower portion of FIG. 1 with respect to 40a-g.

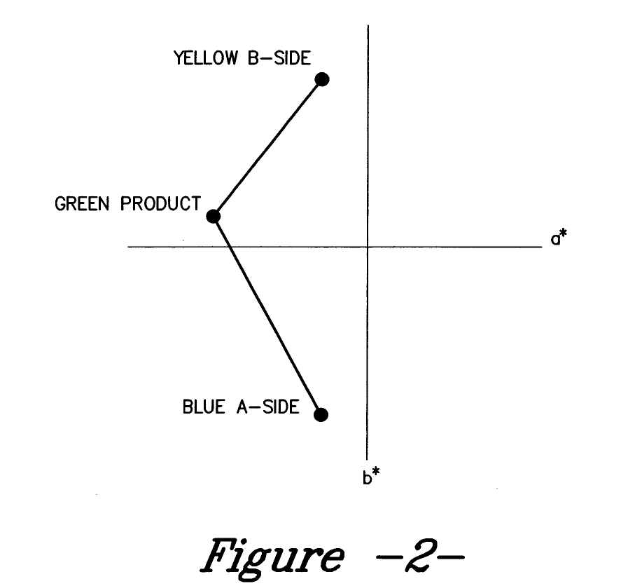

FIG. 2 shows a L,a,b color space coordinate, in which the a* denotes a given color blend that results from the mixing of A and B components. The a* color value occurs anywhere along the color spectrum between Yellow (the B side) and Blue (the A side). The ratio of colorant in A/B is proportional to the amount of A and B reactants that are used in forming the polymer.

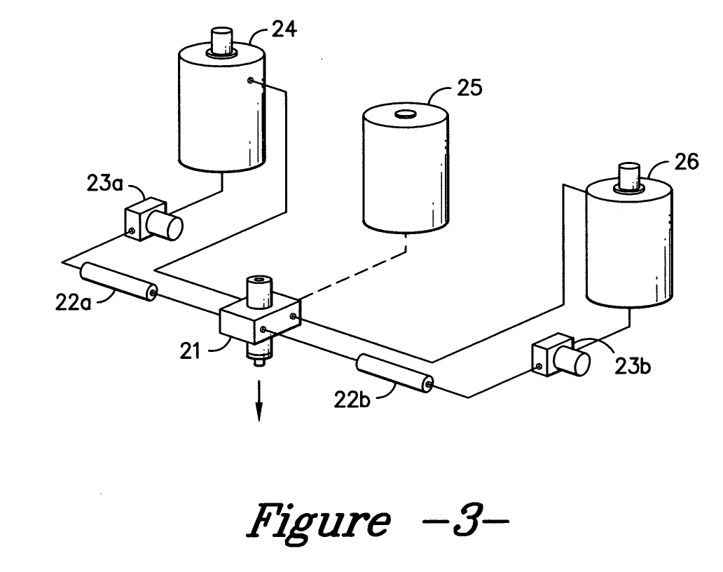

The schematic in FIG. 3 shows an A/B mixing system that can be used in the practice of the invention. These instruments may be either high pressure or low pressure, depending upon the particular application. Low pressure refers in general to systems with less than about 300 psi pressure.

In the FIG. 3, a polyol tank 24 contains the A component, and tank 26 contains isocyanate. A pump 23a delivers polyol from tank 24 to the mix head 21. Likewise, pump 23b delivers isocyanate from tank 26 to mix head 21. Heat exchangers 22a and 22b are shown in-line, and the polyol and isocyanate reactants each pass through such respective heat exchangers on their pathway to the mix head 21. A solvent from tank 25 is applied to the mix head 21, and a dispensed mixture emerges from the mix head 21 (see lower portion of mix head 21 in FIG. 3).

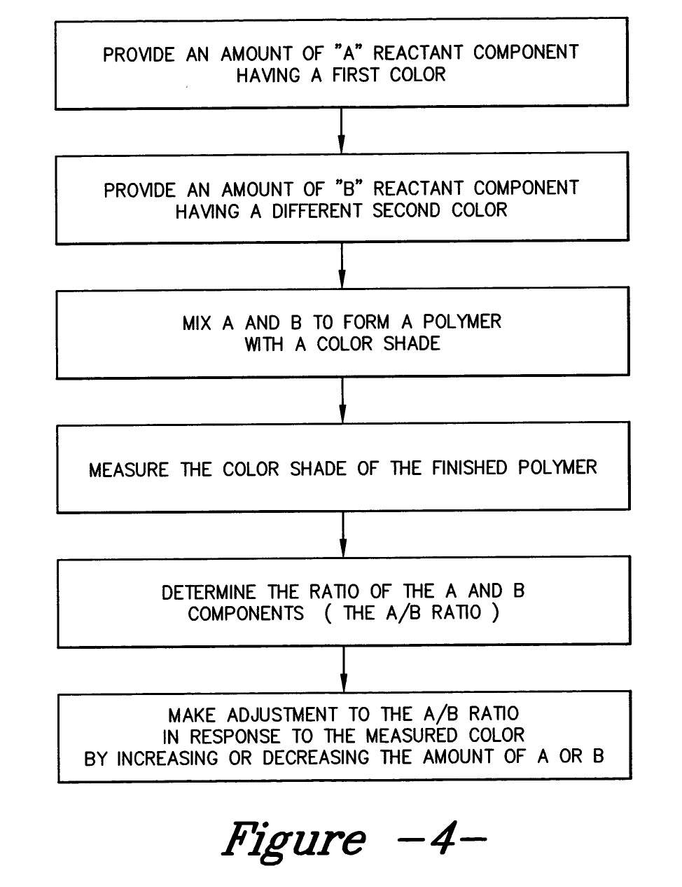

FIG. 4 shows a functional description of the application of the invention in a two-component polymer. First, a given amount of reactant A Component and the reactant B Component are mixed together. A and B mix to form a polymer having a given color shade. Then, one can measure the color shade of the blended polymer thus formed, to determine the ratio of A/B employed in the reaction. Then, it is possible to make adjustments to the A/B ratio in response to the measured color by increasing or decreasing the amount of A or B employed in the reaction. In this way, a feedback loop may be employed to adjust (even in real time during the process) the amount of reactants. This avoids wasting reactants, and facilitates the manufacture of polymer products or materials having high quality, and the appropriate amount of A relative to B for such a multi-component polymer system.

### Testing and Procedures

Several urethane pieces that were produced by mixing an A-side component (isocyanate) with a B-side component (polyol). A two component elastomer system made and distributed by Dow Chemical Company of Midland, Mich., was used. This material was used as a model system and variations in the type of system are not believed to impact the testing. Various colors were added to the A-side (Color 1) and the B-side (Color 2) the details of which are described in the examples.

To manufacture the urethane polymer, the A-side (Color 1) and B-side (Color 2) were mixed for about 20 seconds using a mechanical mixer after which the material (Color 3) was poured onto a plastic sheet. The part was allowed to cure and harden for approximately 2 hours. The cured part was then analyzed using a Hunter Macbeth Ultrascan XE to analyze the resulting blended color (Color 3) of the part.

For each colored part a quantity of liquid polymeric color was introduced into both the A and B side material. The color was in both cases (A and B) thoroughly mixed.

The three A/B ratios used for each final color part were 0.914, 0.959, and 1.005. This correlated to a mixture of: 9.14 (Ratio 1); 9.59 (Ratio 2), and 10.05 (Ratio 3) grams of A-side material respectively to 10 grams of B-side material.

### Dark Black

### EXAMPLE 1

0.0427 grams of REACTINT® Yellow X15 and 0.0005 grams of REACTINT Red X64 were mixed into 50 grams of A-side material. 0.0485 grams of REACTINT® Blue X17 and 0.0083 grams of REACTINT Violet X80 were mixed into 50 grams of B-side material.

A mixture of 9.14 (Ratio 1), 9.59 (Ratio 2), 10.05 (Ratio 3) grams of A-side material respectively to 10 grams of B-side material was used to make a total of three parts. The color of each of the parts resulting from the different ratio was analyzed on the Hunter color computer.

### Medium Black

### EXAMPLE 2

The concentration of the dark black was diluted in half in the respective a and b side solutions to make a new set of solutions for the medium black.

A mixture of 9.14 (Ratio 1), 9.59 (Ratio 2), 10.05 (Ratio 3) grams of the lighter colored A-side material to 10 grams of B-side material was used to make three parts. The color of each of the parts resulting from the different ratio was analyzed on the Hunter color computer.

### Light Black

### EXAMPLE 3

The concentration of the medium black was diluted in half in the respective a and b side solutions to make a new set of solutions for the light black.

A mixture of 9.14 (Ratio 1), 9.59 (Ratio 2), 10.05 (Ratio 3) grams of the lighter colored A-side material to 10 grams of B-side material was used to make three parts. The color of each of the parts resulting from the different ratio was analyzed on the Hunter color computer.

### Orange

### EXAMPLE 4

0.05 grams of REACTINT® Yellow X15 (Milliken and Company, Spartanburg, S.C.) was mixed into 50 grams of A-side material.

0.05 grams of REACTINT® Red X64 (Milliken and Company, Spartanburg, S.C.) were mixed into 50 grams of B-side material.

A mixture of 9.14 (Ratio 1), 9.59 (Ratio 2), 10.05 (Ratio 3) grams of A-side material respectively to 10 grams of B-side material was used to make a total of three parts. The color of each of the parts resulting from the different ratio was analyzed on the Hunter color computer.

A study was conducted to observe if the color of the final part (color 3) could be used to identify the ratio of A (Color 1) and B (Color 2). The three A/B ratios used for each part were 0.914 (Ratio 1), 0.959 (Ratio 2), 1.005 (Ratio 3).

### Pigmented Orange

### EXAMPLE 5

0.050 grams of Aricor Red pigment was mixed into 50 grams of A-side material. 0.050 grams of Aricor Yellow pigment was mixed into 50 grams of B-side material.

A mixture of 9.14 (Ratio 1), 9.59 (Ratio 2), 10.05 (Ratio 3) grams of A-side material respectively to 10 grams of B-side material was used to make a total of three parts. The color of each of the parts resulting from the different ratio was analyzed on a Hunter color computer.

### EXAMPLE 1

### Color Determination Results

The color for the three dark black parts is shown in the chart below:

| | L | a | b |
|---|---|---|---|
| Ratio 1 | 33.26 | 0.9 | −1.37 |
| Ratio 2 | 36.28 | 1.35 | 0.11 |
| Ratio 3 | 36.71 | 1.93 | 0.34 |

In all three measurements there is a systematic change.

### EXAMPLE 2

### Color Determination Results

The color for the three medium black parts is shown in the chart below

| | L | a | b |
|---|---|---|---|
| Ratio 1 | 41.1 | 1.35 | 0.74 |
| Ratio 2 | 45.33 | 1.07 | 1.04 |
| Ratio 3 | 42.80 | 1.66 | 1.51 |

There is a systematic change in the b value.

### EXAMPLE 3

### The Color Determination Results

The color for the three light black parts is shown in the chart below:

| | L | a | b |
|---|---|---|---|
| Ratio 1 | 56.16 | −0.1 | 3.64 |
| Ratio 2 | 55.14 | 0.32 | 3.83 |
| Ratio 3 | 55.11 | 0.87 | 4.21 |

In all three measurements there is a systematic change.

### EXAMPLE 4

### Color Determination Results

The color for the three orange parts is shown in the chart below:

| | L | a | b |
|---|---|---|---|
| Ratio 1 | 57.37 | 38.39 | 28.73 |
| Ratio 2 | 57.48 | 40.93 | 31.62 |
| Ratio 3 | 55.74 | 43.12 | 32.37 |

In all three measurements there is a systematic change.

### EXAMPLE 5

### Color Determination Results

The color for the three pigmented orange parts is shown in the chart below:

| | L | a | b |
|---|---|---|---|
| Ratio 1 | 67.44 | 25.50 | 30.61 |
| Ratio 2 | 64.26 | 28.12 | 31.20 |
| Ratio 3 | 64.63 | 28.13 | 30.25 |

There is a systematic change in the shade calculated from the coordinates.

### Test Evaluation

Each of the Examples 1-4 provided a periodic color change when the color values were plotted in L,a,b color space. This periodic shift can be used to understand and determine the ratios of the A and B reactants used in the polymer system. This makes it possible to then adjust the amount of A or B (or both A and B), to thereby reliably form a polymer having a more precisely correct ratio of A/B.

Furthermore, when the two-component system is not mixed together homogenously, a mottled poor quality part results. The contrast provided by having different colors in each of the A and B sides is far greater than the contrast provided by the incorporation of color to a single side. Thus, homogenous mixing is clearly observed using the approach described in the examples.

It is understood by one of ordinary skill in the art that the present discussion is a description of exemplary embodiments only, and is not intended as limiting the broader aspects of the present invention, which broader aspects are embodied in the exemplary constructions. The invention is shown by example in the appended claims.

What is claimed is:

1. A method of measuring the amount of at least one reactant used in forming a polymeric material, said method comprising the steps of:
(a) providing a first reactant having a first polymeric colorant;
(b) providing a second reactant having a second polymeric colorant, said second polymeric colorant having a different color as compared to said first polymeric colorant;
(c) reacting said first reactant with said second reactant to form a polymeric material, said polymeric material exhibiting a resulting color;
(d) observing said resulting color;
(e) correlating said observation in step (d) to a ratio of said first reactant to said second reactant; thereby
(f) determining the relative proportion of said first reactant to said second reactant employed in the providing steps (a) and (b).

2. The method of claim 1 wherein said color observation of step (d) is measured in color space values such as L*, a* and b*.

3. The method of claim 1 wherein said correlation in step (e) is provided by matching said color with corresponding predetermined ratios.

4. The method of claim 1 wherein said polymeric material comprises polyurethane.

5. The method of claim 4 wherein said first reactant comprises an isocyanate.

6. The method of claim 4 wherein said second reactant comprises a polyol.

7. The method of claim 1 wherein said first and second reactants are combined in a mix head during said reacting step (c).

8. The method of claim 1, further comprising the following step:
(g) comparing said determined relative proportion in step (e) with a predetermined value; and
(h) adjusting the relative proportion of said first reactant to said second reactant, thereby tuning said relative proportion to a desired ratio.

9. A method of measuring the amount of at least one reactant used in forming a polymeric material, said method comprising the steps of:
(a) providing a first reactant having a first coloring agent;
(b) providing a second reactant having a second coloring agent, said second coloring agent having a different color as compared to said first coloring agent;
(c) reacting said first reactant with said second reactant to form a polymeric material, said polymeric material exhibiting a resulting color;
(d) measuring said resulting color;
(e) correlating said measured color in step (d) to a ratio of said first reactant to said second reactant; thereby
(f) determining the relative proportion of said first reactant to said second reactant employed in the providing steps (a) and (b).

10. A method of evaluating or monitoring the ratio between one or more reactants in a chemical system in which said reactants are chemically combined to form a colored product, in which said method relates to the observation of the color of the products, in which the ratio of the respective reactants may be determined or adjusted.

11. A method of monitoring the degree of homogeneity of a blend of multi-component reactant systems by coloring each component which forms the multi-component reactant system individually, each component having a respective color, and then observing or measuring the presence or absence of colors striations in the multi-component system.
